(19) United States
(12) Patent Application Publication
(10) Pub. No.: US 2026/0283750 A1
(43) Pub. Date: Sep. 24, 2026

(54) ATTACHMENT MOUNTING TEMPLATE ASSEMBLY

(71) Applicant: WUXI EA MEDICAL INSTRUMENTS TECHNOLOGIES LIMITED, Wuxi (CN)

(72) Inventors: Yikan Zheng, Shanghai (CN); Junsheng Li, Shanghai (CN); Lei Huang, Shanghai (CN); Chuncheng Zhang, Shanghai (CN)

(21) Appl. No.: 19/685,835

(22) Filed: May 22, 2026

Related U.S. Application Data
(63) Continuation of application No. 18/225,903, filed on Jul. 25, 2023, now abandoned.
Application No. 18/225,903 is a continuation of application No. PCT/CN2021/142025, filed on Dec. 28, 2021.

(30) Foreign Application Priority Data
Jan. 26, 2021 (CN) 202110108845.2
Jan. 26, 2021 (CN) 202110108974.1
Jan. 26, 2021 (CN) 202110109313.0

(51) Int. Cl. A61C 7/08

(52) U.S. Cl. CPC A61C 7/08

(57) ABSTRACT

An attachment mounting template assembly for adhering an attachment at a selected position on a surface of a selected tooth includes (i) an attachment mounting template, which is a one-piece shell, and forms a tooth-receiving cavity and an attachment holder receiving portion at a selected position, (ii) an attachment holder received in the attachment holder receiving portion for retaining and correctly positioning an attachment within the attachment holder receiving portion, and (iii) an attachment which is to be adhered onto a tooth’s surface to form a protrusion, and to interact with a shell-shaped tooth repositioner to provide an auxiliary force system for an orthodontic treatment. The attachment holder is located between the attachment holder receiving portion and the attachment. When the attachment mounting template assembly is put on a patient’s teeth, the attachment is located at a selected position on a surface of a selected tooth.

### CROSS-REFERENCE TO RELATED APPLICATIONS

This is a continuation of U.S. Patent Application No. 18/225,903, filed Jul. 25, 2023, which is a continuation of International Patent Application No. PCT/CN2021/142025, filed Dec. 28, 2021, which claims the priority benefit of Chinese Patent Application No. 202110109313.0, filed Jan. 26, 2021, Chinese Patent Application No. 202110108845.2, filed Jan. 26, 2021, and Chinese Patent Application No. 202110108974.1, filed Jan. 26, 2021, the entire contents of each of which are hereby incorporated by reference herein.

### FIELD OF THE APPLICATION

The present application generally relates to an attachment mounting template assembly for adhering an attachment to a selected position on a surface of a selected tooth.

### BACKGROUND

Shell-shaped tooth repositioners made of polymer materials become more and more popular due to their advantages on aesthetic appearance, convenience and ease to clean. An orthodontic treatment utilizing shell-shaped tooth repositioners usually requires a series of successive shell-shaped tooth repositioners. A geometry of a tooth-receiving cavity of each of these shell-shaped tooth repositioners substantially matches a tooth arrangement to be achieved by a corresponding treatment step.

In many cases, it is difficult to ensure that a repositioning force system having appropriate magnitude and direction will be applied by a shell-shaped tooth repositioner itself only. For example, when a tooth is repositioned along the mesial or distal direction, although a desired repositioning manner is translation, a large tipping torque is apt to be generated in actual operations, thereby causing excessive repositioning of an incisal edge of the tooth along the direction, and thereby causing the tooth to undergo undesired tipping. In clinic applications, to avoid the above problem and to apply on the tooth a repositioning force system closer to a design target, it is usually necessary to additionally fix a protruding attachment having a certain outer shape on the tooth by a method such as adhesion, and to form a corresponding cavity for receiving the attachment on the shell-shaped tooth repositioner. An assistant force system is applied on the tooth through squeeze and friction between the cavity and the accessory, so that the total repositioning force system applied on the tooth is closer to the desired force system. It can be seen from the above that attachment is crucial for an orthodontic treatment using shell-shaped tooth repositioners.

Since the size of an attachment is usually small (e.g., 2-3 mm), it is a challenge to precisely and firmly fix an attachment at a predetermined position on a tooth surface. Currently, there are two attachment mounting methods: One is to fill an uncured attachment material in a receiving cavity having the same geometry as the attachment, at a predetermined position of an attachment template similar to a shell-shaped tooth repositioner, and after the attachment template is worn on a patient’s teeth, let the attachment material to cure and to firmly adhere onto a tooth of the patient at the predetermined position. The other is to place a preformed attachment, whose bottom is applied an adhesive, into a receiving cavity having the same geometry as the attachment, at a predetermined position of an attachment template similar to a shell-shaped tooth repositioner, and then put the attachment template on a patient’s teeth, the preformed attachment is adhered onto a tooth of the patient at the predetermined position after the adhesive cures.

As for the above first method, since an uncured material such as a photocurable material for fabricating the attachment is usually costly, the overall cost of the first method is very high. As for the above second method, since the size of an attachment is small, it is very difficult to ensure that the attachment is placed in the receiving cavity in a correct direction.

In view of the above, it is necessary to provide a new attachment mounting method.

### SUMMARY

In one aspect, the present application provides an attachment and attachment holder assembly, which comprises: an attachment which is to be adhered onto a tooth’s surface to form a protrusion and to interact with a shell-shaped tooth repositioner to provide an auxiliary force system for an orthodontic treatment; and an attachment holder configured to hold and position the attachment in an attachment holder receiving portion of an attachment mounting template for mounting the attachment, wherein the attachment mounting template is a one-piece shell, which forms a tooth-receiving cavity, and the attachment holder receiving portion at a predetermined position, when the attachment and attachment holder assembly is received in the attachment holder receiving portion, the attachment holder is located between the attachment mounting template and the attachment.

In some embodiments, the attachment and the attachment holder may be integrally formed and fixed to each other by a weakened part.

In some embodiments, the attachment and the attachment holder may be fixed to each other by an adhesive or a retaining structure.

In some embodiments, the attachment holder may comprise a plurality of fins distributed around the attachment, to position the attachment in the attachment holder receiving portion.

In some embodiments, the attachment holder may comprise a closed sidewall that surrounds the attachment.

In some embodiments, the attachment holder may form an error-proofing structure capable of preventing the attachment holder from being mounted in the holder receiving portion in a wrong direction.

In some embodiments, an adhesion layer may be provided on a surface of the attachment on a side adjacent to the tooth, to adhere the attachment onto the tooth’s surface.

In some embodiments, the assembly may further comprise an isolation film fixed on the edge of a bottom side of the attachment holder, to isolate the adhesion layer.

In some embodiments, the attachment may be made of a first material with a high hardness, the attachment holder may be made of an elastic second material, the attachment holder is squeezed by the attachment and the attachment holder receiving portion, thereby retaining and correctly positioning the attachment in the attachment holder receiving portion.

In another aspect, the present application provides an attachment mounting template assembly for adhering an attachment at a selected position on a surface of a selected tooth, it comprises: an attachment mounting template, which is a one-piece shell, and forms a tooth-receiving cavity and an attachment holder receiving portion at a selected position; an attachment holder received in the attachment holder receiving portion for retaining and correctly positioning an attachment within the attachment holder receiving portion; and an attachment which is to be adhered onto a tooth’s surface to form a protrusion and to interact with a shell-shaped tooth repositioner to provide an auxiliary force system for an orthodontic treatment, wherein the attachment holder is located between the attachment holder receiving portion and the attachment, and when the attachment mounting template assembly is put on a patient’s teeth, the attachment is located at a selected position on the surface of a selected tooth.

In some embodiments, the attachment holder may be fixed in the attachment holder receiving portion by an adhesive or a retaining structure.

In some embodiments, the attachment and the attachment holder may be integrally formed and fixed to each other by a weakened part.

In some embodiments, the attachment and the attachment holder may be fixed to each other by an adhesive or a retaining structure.

In some embodiments, the attachment holder and the attachment holder receiving portion may form an error-proofing structure capable of preventing the attachment holder from being mounted in the holder receiving portion in a wrong direction.

In some embodiments, the attachment holder may comprise a plurality of fins distributed around the attachment, to correctly position the attachment in the attachment holder receiving portion.

In some embodiments, an adhesion layer may be provided on a surface of the attachment on a side adjacent to the tooth for adhering the attachment onto the tooth’s surface.

In some embodiments, the assembly may further comprise an isolation film fixed at the edge of a bottom side of the attachment holder, to isolate the adhesion layer.

In some embodiments, the attachment may be made of a first material with a high hardness, the attachment holder may be made of an elastic second material, the attachment holder is squeezed by the attachment and the attachment holder receiving portion, to retain and correctly position the attachment in the attachment holder receiving portion.

In a further aspect, the present application provides a method of adhering an attachment onto a tooth’s surface, the method comprises: putting the attachment mounting template assembly on a patient’s teeth; adhering the attachment at a selected position on the selected tooth’s surface; and removing the attachment mounting template and the attachment holder.

In some embodiments, the method may further comprise: before the attachment holder is detached from the attachment, removing the attachment template from the patient’s teeth so that the attachment holder is detached from the attachment holder receiving portion.

In a further aspect, the present application provides a method of fabricating an attachment mounting template assembly, for adhering an attachment at a selected position on a surface of a selected tooth of a patient, the method comprises: obtaining an attachment mounting template, which is a one-piece shell, and forms a tooth-receiving cavity an attachment holder receiving portion for receiving an attachment holder at a selected position; obtaining mounting information of an attachment and attachment holder assembly based on identity information of the attachment mounting template; and according to the mounting information of the attachment and attachment holder assembly, mounting the attachment and attachment holder assembly in the attachment holder receiving portion in a corresponding direction to obtain an attachment mounting template assembly, wherein the attachment holder is located between the attachment and the attachment holder receiving portion to retain and correctly position the attachment in the attachment holder receiving portion, when the attachment mounting template assembly is put on the patient’s teeth, the attachment is located at the selected position of the surface of the selected tooth.

In some embodiments, the method may further comprise: using an apparatus to read an identity mark on the attachment mounting template to obtain the identity information.

In some embodiments, the identity mark may be a QR code.

In some embodiments, the mounting information of the attachment and attachment holder assembly may be graphically shown on a display, and the attachment mounting information may comprise a mounting direction of the attachment and attachment holder assembly.

In some embodiments, the mounting information of the attachment and attachment holder assembly may further comprise a type of the attachment and attachment holder assembly, wherein the type of the attachment and attachment holder assembly may be represented with a color and/or a shape.

In a further aspect, the present application provides an attachment and attachment holder assembly, which comprises: an attachment which is to be adhered onto a tooth’s surface to form a protrusion and to interact with a shell-shaped tooth repositioner to provide an auxiliary force system for an orthodontic treatment, wherein the attachment forms a hollow portion extending from a top surface to a bottom surface to allow an adhesive to be injected from the top surface and fill the hollow portion and to be applied on the bottom surface; and an attachment holder to retain and correctly position the attachment in an attachment holder receiving portion of an attachment mounting template to mount the attachment, wherein the attachment mounting template is a one-piece shell, which forms a tooth-receiving cavity and the attachment holder receiving portion at a predetermined position, when the attachment and attachment holder assembly is received in the attachment holder receiving portion, the attachment holder is located between the attachment mounting template and the attachment.

In some embodiments, the attachment and the attachment holder are integrally formed and fixed to each other by a weakened part.

In some embodiments, the attachment and the attachment holder are fixed to each other by an adhesive or a retaining structure.

In some embodiments, the attachment holder may comprise a plurality of fins distributed around the attachment, to correctly position the attachment in the attachment holder receiving portion.

In some embodiments, the attachment holder may comprise a sidewall which is closed surrounds the attachment.

In some embodiments, the attachment holder forms an error-proofing structure capable of preventing the attachment holder from being mounted in the holder receiving portion in a wrong direction.

In some embodiments, an adhesive storage portion in fluid communication with the hollow portion is provided on a side of the attachment holder away from the tooth, and an adhesive stored in the adhesive storage portion will be squeezed out and injected into the hollow portion after the adhesive storage portion is squeezed.

In some embodiments, the adhesive storage portion may be an adhesive storage bladder, when it is squeezed, it will collapse and the adhesive stored therein will be injected into the hollow portion.

In some embodiments, a seal made of a highly elastic material may be provided between the adhesive storage bladder and the hollow portion, when the adhesive storage bladder is not squeezed, an opening of the seal is closed to prevent leakage of the adhesive from the adhesive storage bladder, when the adhesive storage bladder is squeezed, the opening of the seal is forced to open to inject the adhesive stored in the adhesive storage bladder into the hollow portion.

In some embodiments, a plug that matches an opening of the adhesive storage bladder is provided in the adhesive storage bladder opposed to the hollow portion, and the plug will be inserted into the opening of the adhesive storage bladder when the adhesive storage bladder is fully squeezed.

In some embodiments, the adhesive storage potion may comprise an adhesive storage reservoir and a piston that match with each other, wherein the adhesive storage reservoir is in fluid communication with the hollow portion, and after the piston is pressed, the adhesive is squeezed from the adhesive storage reservoir into the hollow portion.

In some embodiments, a seal made of a highly elastic material is provided between the adhesive storage reservoir and the hollow portion, when the piston is not pushed down, an opening of the seal is closed to prevent leakage of the adhesive from the adhesive storage reservoir, when the piston is pushed down, the opening of the seal is forced to open such that the adhesive stored in the adhesive storage reservoir is injected into the hollow portion.

In some embodiments, the attachment may be made of a first material, the adhesive storage portion may be made of a second material, and the adhesive strength of the adhesive to the first material is higher than that of the adhesive to the second material.

In a further aspect, the present application provides an attachment mounting template assembly for adhering an attachment at a selected position on a surface of a selected tooth, it comprises: an attachment mounting template, which is a one-piece shell, and forms a tooth-receiving cavity and an attachment holder receiving portion for receiving an attachment holder at a selected position; an attachment holder received in the attachment holder receiving portion for retaining and correctly positioning an attachment within the attachment holder receiving portion; and an attachment which is to be adhered onto a tooth’s surface to form a protrusion and to interact with a shell-shaped tooth repositioner to provide an auxiliary force system for an orthodontic treatment, the attachment forms a hollow portion extending from a top surface to a bottom surface to allow an adhesive to be injected from the top surface to fill the hollow portion and to be applied on the bottom surface; wherein the attachment holder is located between the attachment holder receiving portion and the attachment, when the attachment mounting template assembly is put on a patient’s teeth, the attachment is located at the selected position on the surface of the selected tooth.

In some embodiments, the attachment holder may be fixed in the attachment holder receiving portion by an adhesive or a retaining structure.

In some embodiments, the attachment and the attachment holder may be integrally formed and fixed to each other by a weakened part.

In some embodiments, the attachment and the attachment holder may be fixed to each other by an adhesive or a retaining structure.

In some embodiments, the attachment holder and the attachment holder receiving portion may form an error-proofing structure capable of preventing the attachment holder from being mounted in the holder receiving portion in a wrong direction.

In some embodiments, the attachment holder may comprise a plurality of fins distributed around the attachment, to correctly position the attachment in the attachment holder receiving portion.

In some embodiments, the attachment holder receiving portion is provided with an opening so that an adhesive injector can go through the opening to inject an adhesive into the hollow portion.

In some embodiments, an adhesive storage portion in fluid communication with the hollow portion is provided on a side of the attachment holder away from the tooth, and an adhesive stored in the adhesive storage portion will be squeezed out and injected into the hollow portion after the adhesive storage portion is squeezed.

In some embodiments, the adhesive storage portion may be an adhesive storage bladder, when it is squeezed, it will collapse and the adhesive stored therein will be injected into the hollow portion.

In some embodiments, a seal made of a highly elastic material may be provided between the adhesive storage bladder and the hollow portion, when the adhesive storage bladder is not squeezed, an opening of the seal is closed to prevent leakage of the adhesive from the adhesive storage bladder, when the adhesive storage bladder is squeezed, the opening of the seal is forced to open and the adhesive stored in the adhesive storage bladder is injected into the hollow portion.

In some embodiments, a plug that matches an opening of the adhesive storage bladder may be provided in the adhesive storage portion opposed to the hollow portion, and the plug will be inserted into the opening of the adhesive storage bladder when the adhesive storage bladder is fully squeezed.

In some embodiments, the adhesive storage potion may comprise an adhesive storage reservoir and a piston that match each other, wherein the adhesive storage reservoir is in fluid communication with the hollow portion, and after the piston is pushed, the adhesive will be discharged from the adhesive storage reservoir into the hollow portion.

In some embodiments, the attachment may be made of a first material, the adhesive storage portion may be made of a second material, the adhesive strength of the adhesive to the first material is higher than that of the adhesive to the second material.

In a further aspect, the present application provides a method of adhering an attachment onto a tooth’s surface, the method comprises: putting the attachment mounting template assembly on a patient’s teeth; injecting the adhesive into the hollow portion of the attachment to fill the hollow portion and to cover the bottom surface of the attachment; curing the adhesive so that the adhesive forms a part of the attachment and adheres the attachment at a selected position on the surface of the selected tooth; and removing the attachment mounting template and the attachment holder.

In some embodiments, the method may further comprise: before removing the attachment holder from the attachment, removing the attachment template from the patient’s teeth so that the attachment holder detaches from the attachment holder receiving portion.

### BRIEF DESCRIPTION OF THE DRAWINGS

The above and other features of the present application will be further illustrated below with reference to figures and their detailed description. It should be appreciated that these figures only show several exemplary embodiments according to the present application, so they should not be construed as limiting the scope of the present application. Unless otherwise specified, the figures are not necessarily drawn to scale, and similar reference numbers therein denote similar components.

FIG. 1 schematically illustrates an attachment mounting template according to one embodiment of the present application;

FIG. 2A schematically illustrates an attachment holder received in an attachment holder receiving portion according to one embodiment of the present application;

FIG. 2B schematically illustrates an attachment holder received in an attachment holder receiving portion according to another embodiment of the present application;

FIG. 3A schematically illustrates engagement between sidewalls of an attachment holder receiving portion and the accessary holder according to an embodiment of the present application;

FIG. 3B schematically illustrates engagement between sidewalls of an attachment holder receiving portion and an attachment holder according to another embodiment of the present application;

FIG. 4A schematically illustrates an attachment holder according to one embodiment of the present application;

FIG. 4B schematically illustrates an attachment holder according to another embodiment of the present application;

FIG. 4C schematically illustrates an attachment holder according to a further embodiment of the present application;

FIG. 4D schematically illustrates an attachment holder and an attachment according to a further embodiment of the present application;

FIG. 4E schematically illustrates an attachment holder according to a further embodiment of the present application;

FIG. 4F schematically illustrates an attachment holder according to a further embodiment of the present application;

FIG. 4G schematically illustrates an attachment holder according to a further embodiment of the present application;

FIG. 4H schematically illustrates an attachment holder and an attachment according to a further embodiment of the present application;

FIG. 5 schematically illustrates a part of an attachment mounting template assembly according to one embodiment of the present application;

FIG. 6 illustrates a schematic flow chart of a method of fabricating an attachment mounting template assembly according to one embodiment of the present application;

FIG. 7 schematically illustrates a part of an attachment mounting template assembly according to another embodiment of the present application;

FIG. 8A schematically illustrates a cross section of an assembly of an attachment and an attachment holder according to one embodiment of the present application;

FIG. 8B schematically illustrates the status of the adhesive storing portion of the attachment holder shown in FIG. 8A after it is squeezed;

FIG. 9A schematically illustrates an attachment holder according to a further embodiment of the present application;

FIG. 9B schematically illustrates the sealing element shown in FIG. 9A;

FIG. 10A schematically illustrates a cross section of an assembly of an attachment and an attachment according to one embodiment of the present application;

FIG. 10B schematically illustrate an adhesive storing portion shown in FIG. 10A from another perspective;

FIG. 11A schematically illustrates a cross section of an attachment according to another embodiment of the present application;

FIG. 11B schematically illustrates a cross section of an attachment according to a further embodiment of the present application;

FIG. 11C schematically illustrates a cross section of an attachment according to a further embodiment of the present application;

FIG. 11D schematically illustrates a cross section of an attachment according to a further embodiment of the present application; and

FIG. 12 illustrates a schematic flow chart of a method of fixing an attachment onto a tooth’s surface by adhesion according to one embodiment of the present application.

### DETAILED DESCRIPTION OF ILLUSTRATED EMBODIMENTS

In the following detailed description, reference is made to the accompanying drawings, which form a part thereof. Exemplary embodiments in the detailed description and figures are only intended for illustration purpose and not meant to be limiting. Inspired by the present application, those skilled in the art can understand that other embodiments may be utilized and other changes may be made, without departing from the spirit or scope of the present application. It will be readily understood that aspects of the present application described and illustrated herein can be arranged, replaced, combined, separated and designed in a wide variety of different configurations, all of which are explicitly contemplated and make part of the present application.

An orthodontic treatment utilizing shell-shaped tooth repositioners requires a series of successive shell-shaped tooth repositioners. These shell-shaped tooth repositioners are worn in sequence to reposition a patient’s teeth from an initial tooth arrangement to a first intermediate tooth arrangement, a second intermediate tooth arrangement…a final intermediate tooth arrangement, until a target tooth arrangement incrementally.

Each shell-shaped tooth repositioner corresponds to a repositioning step and is used to reposition the patient’s teeth from an initial tooth arrangement of the repositioning step to a target tooth arrangement of the repositioning step. Usually, a shell-shaped tooth repositioner is an integral shell, and forms a cavity for receiving teeth. The geometry of the cavity substantially matches the target tooth arrangement of the corresponding repositioning step. A shell-shaped tooth repositioner is fabricated based on the target tooth arrangement of each repositioning step.

In many cases, it is difficult to ensure that a repositioning force system having a proper magnitude and direction will be applied on a tooth merely by a shell-shaped tooth repositioner itself. In such situation, it is necessary to fix a protruding attachment having a certain outer shape on the tooth by a method such as adhesion, and to form a corresponding attachment receiving cavity on the shell-shaped tooth repositioner. An auxiliary force system is applied on the tooth through squeeze and friction between the cavity and the attachment, to achieve treatment target more effectively.

In order to overcome the drawbacks of the prior arts, one aspect of the present application provides a new method for mounting attachment.

The attachment mounting method uses an attachment mounting template assembly to mount an attachment, and the attachment mounting template assembly includes an attachment mounting template, an attachment holder and an attachment. The accessory mounting template is in a one-piece shell, which forms a tooth-receiving cavity and an attachment holder receiving portion at a predetermined position. The attachment holder is received in the holder receiving portion, the attachment holder is between the attachment holder receiving portion and the attachment, to keep the attachment within the attachment holder receiving portion. The attachment holder receiving portion forms an opening on a side closer to a tooth so that the attachment can be adhered to the tooth surface. An adhesive is provided on a surface of the attachment on a side adjacent to the tooth. The attachment mounting template assembly is worn on the patient’s dentition. The attachment can be adhered at a predetermined position onto the tooth by curing the adhesive. On the one hand, since the attachment is preformed, i.e., it is a cured attachment product, it may be made of an economical material by a conventional method such as injection-molding or sintering, and needn’t be made of a costly photocurable material, thereby effectively lowering the cost. On the other hand, the attachment holder has a larger size than the attachment so that the attachment holder and the attachment can be more easily placed in the attachment holder receiving portion in a correct direction manually or by a machine.

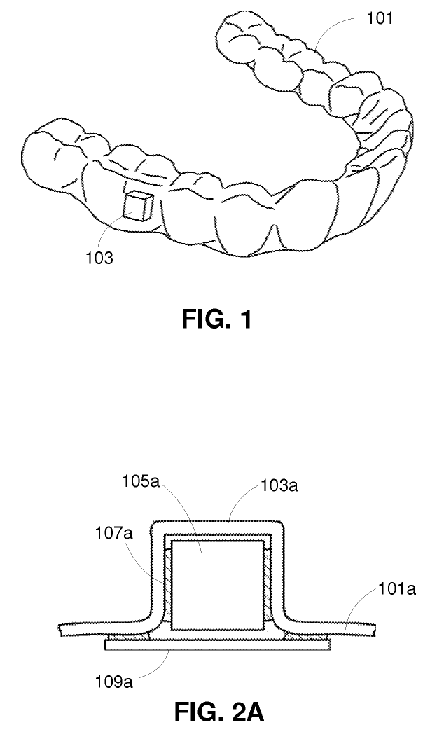

Referring to FIG. 1, it schematically illustrates an attachment mounting template 101 according to one embodiment of the present application.

The attachment mounting template 101 is substantially a one-piece shell, which forms a tooth-receiving cavity an attachment holder receiving portion 103 at a predetermined position to receive an attachment holder.

In some embodiments, the attachment template may be made by a method similar to that of a shell-shaped tooth repositioner. In one embodiment, the attachment template may be made by a thermoplastic forming process. For example, a first 3D digital model representing a patient’s current tooth arrangement may be obtained first. Then, a 3D body having the same geometry as a holder receiving portion is added at a corresponding position on the first 3D digital model according to an attachment mounting position to obtain a second 3D digital model. Then, the second 3D digital model may be used to control a device (e.g., a 3D printing device) to make a physical model. In the end, the attachment template is formed on the physical model using a polymer sheet material by thermoplastic forming technique.

In another embodiment, the attachment template may also be directly made by a 3D printing technology. For example, a certain thickness may be given based on the second 3D digital model to obtain a third 3D digital model representing the attachment template. Then, the third 3D digital model may be used to control a 3D printing device to print the attachment template.

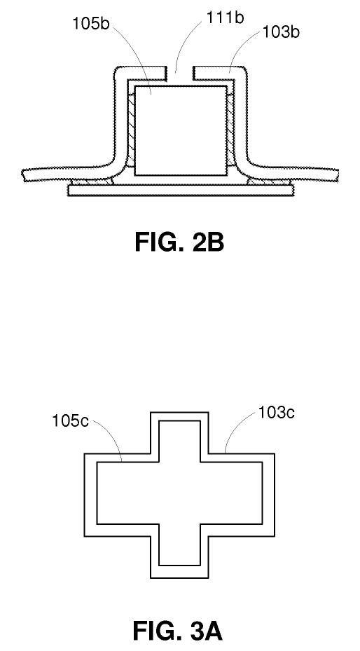

FIG. 2A schematically illustrates an attachment holder 105a received in an attachment holder receiving portion 103a according to one embodiment of the present application.

In the embodiment shown in FIG. 2A, the attachment template 101a forms the accessory holder receiving portion 103a, which is closed on a side opposite to a tooth and forms a receiving cavity, and the attachment holder 105a is received in the receiving cavity. In the present embodiment, the attachment holder 105a is adhered to the accessory holder receiving portion 103a with an adhesive 107a. In the present embodiment, sides of the accessory holder 105a are adhered to sidewalls of the attachment holder receiving portion 103a. Inspired by the present application, it is understood that a top side of the accessory holder 105a may be adhered to a top surface (i.e., an inner surface on a side away from the tooth surface) of the attachment holder receiving portion 103a. In one embodiment, the adhesion of the adhesive 107a may be weaker than that of the adhesive for adhering the attachment onto the tooth surface so that after the attachment is adhered onto the tooth surface, the attachment holder can detach from the attachment template.

In the embodiment shown in FIG. 2A, an isolation film 109a is adhered to an inner surface of the attachment template 101a (i.e., the surface facing teeth), and closes an opening of the attachment holder receiving portion 103a on a side adjacent to the tooth, thereby isolating the attachment holder 105a and the attachment (not shown in the figure) within the attachment holder receiving portion 103a. On the one hand, this can prevent the adhesive applied to the bottom surface (i.e., the adhesion surface) of the attachment from being contaminated; on the other hand, this can prevent detachment of the attachment holder 105a and the attachment from the attachment template 101a during transportation.

Referring to FIG. 2B, it schematically illustrates an attachment holder receiving portion 103b according to another embodiment of the present application. Unlike the embodiment shown in FIG. 2A, the attachment holder receiving portion 103b is provided with an opening 111b on a top side (i.e. the side away from the tooth) to facilitate operation on the attachment holder 105b or the attachment. For example, when the attachment is adhered to the tooth surface, the attachment may be pressed towards the tooth through the opening 111b to better the adhesion of the attachment onto the tooth surface. For example, the attachment may be placed into the attachment holder 105b received in the attachment holder receiving portion 103b through the opening 111b. Inspired by the present application, it is understood that the size and shape of opening 111b may be determined according to specific needs.

Inspired by the present application, it is understood that an attachment holder may be fixed in an attachment holder receiving portion in other manners in addition to adhesion. For example, concave and convex structures that match with each other may be provided on sidewalls of the attachment holder receiving portion and sides of the attachment holder, and the attachment holder may be fixed in the attachment holder receiving portion by engagement of these concave and convex structures.

In one embodiment, the geometry defined by the sidewalls of an attachment holder receiving portion limits the transverse freedoms (along directions on the tooth surface) of the attachment holder, so that the attachment holder cannot rotate and translate, thereby ensuring the accuracy of the attachment mounting position.

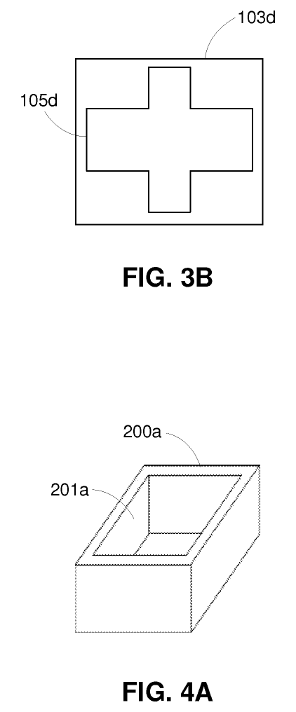

Referring to FIG. 3A, it schematically illustrates the relationship between the side walls of an attachment holder receiving portion 103c and an attachment holder 105c according to one embodiment of the present application. In the present embodiment, the geometry defined by the side walls of the attachment holder receiving portion 103c substantially matches the geometry of the attachment holder 105c to limit transverse freedoms of the attachment holder 105c.

Referring to FIG. 3B, it schematically illustrates the relationship between the side walls of an attachment holder receiving portion 103d and an attachment holder 105d according to a further embodiment of the present application. In the present embodiment, the sidewalls of the accessory holder receiving portion 103d forms a cuboid, the length and width of the cuboid substantially match that of the attachment holder 105d to limit transverse freedoms of the attachment holder 105d.

Inspired by the present application, it is understood that the shape of an attachment holder is not limited to the cross shapes shown in FIG. 3A and FIG. 3B, and it may be any suitable shape. Likewise, it is understood that in addition to the examples shown in FIG. 3A and FIG. 3B, the geometry defined by the sidewalls of an attachment holder receiving portion may also be other geometries that are able to limit transverse freedoms of an attachment holder.

In some embodiments, an attachment holder and an attachment holder receiving portion may have structures that can prevent the attachment holder from being placed into the attachment holder receiving portion in a wrong direction. For example, the geometry of the attachment holder and/or the attachment holder receiving portion is able to prevent the attachment holder from being placed into the attachment holder receiving portion in a wrong direction. For example, the cross-sectional shape of the attachment holder receiving portion may be trapezoidal, and correspondingly, the peripheral contour of the cross section of the attachment holder may also be trapezoidal to prevent the attachment holder from being placed into the attachment holder receiving portion in a wrong direction, thereby preventing the attachment from being adhered to the tooth surface in a wrong direction. For example, a sliding groove and a guide block that match with each other may be provided on the attachment holder and the attachment holder receiving portion respectively to prevent the attachment holder from being placed into the attachment holder receiving portion in a wrong direction.

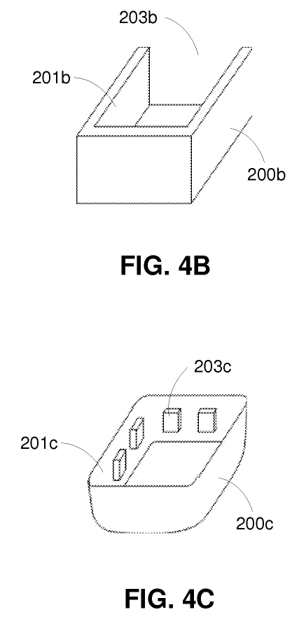

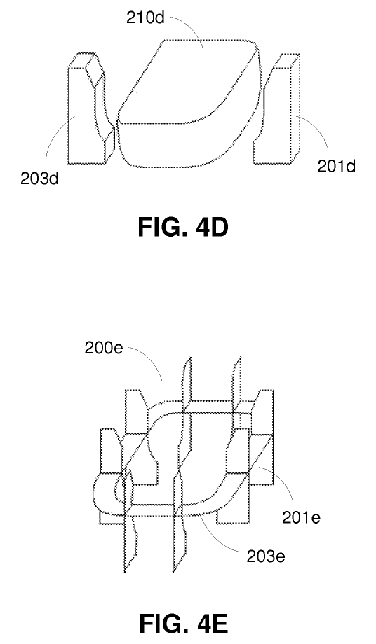

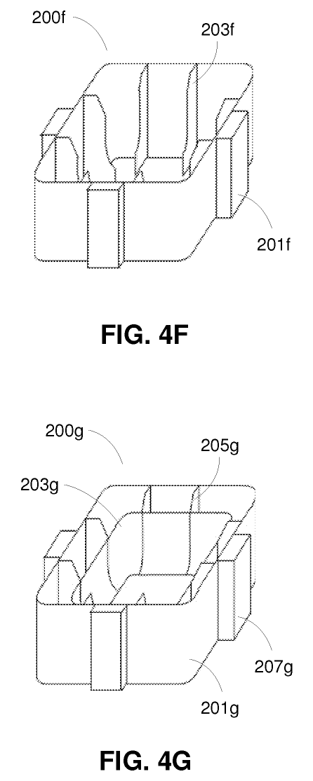

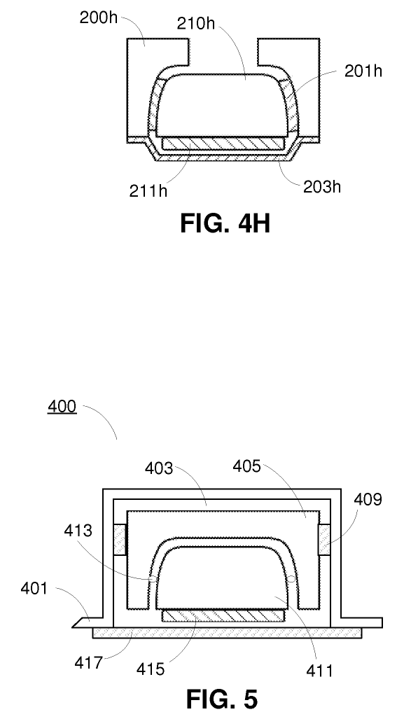

Referring to FIG. 4A, it schematically illustrates an attachment holder 200a according to one embodiment of the present application.

In the present embodiment, the attachment holder 200a is substantially a rectangular box and its bottom side (namely, the side adjacent to the tooth) forms an opening 201a as a channel for an attachment. The box-shaped space defined by the attachment holder 200a is to receive the attachment (not shown in the figure). The attachment and attachment holder 200a may be fixed to each other using means such as adhesive, weakened part and retaining structure etc. After the attachment is adhered onto the tooth surface, the retention between the attachment and the attachment holder 200a can be damaged, thereby making the attachment holder 200a detach from the attachment.

In one embodiment, both bottom and top sides of the attachment holder 200a may be formed with openings.

In one embodiment, an attachment holder and an attachment may be fabricated separately, and then assembled using an automated equipment to obtain an attachment holder and attachment assembly. In another embodiment, the attachment holder and attachment may be integrally formed, and the two may be fixed to each other with a weakened part. The weakened part is a relatively weak part, and its mechanical strength is much lower than the mechanical strength of components (i.e., the attachment holder and the attachment), and the weakened part may be broken with a small force, without damaging the components themselves. For example, the weakened part may be a thin connection or a spaced connection.

In some embodiments, the attachment and attachment holder may be fabricated by a method such as injection molding and 3D printing etc.

Inspired by the present application, it is understood that the shape of an attachment holder is not limited to rectangular box. The geometry of the attachment holder may be determined based on the shape of the attachment and specific needs, as long as the attachment holder and the attachment are fixed to each other, and precise positioning of the attachment on a tooth is ensured.

Since the transverse size of the attachment holder and attachment assembly is substantially larger than the attachment, the attachment is more easier to be placed in the attachment holder receiving portion of the attachment template in a correct direction in practice.

Referring to FIG. 4B, it schematically illustrates an attachment holder 200b according to another embodiment of the present application. Similar to the attachment holder 200a shown in FIG. 4A, the attachment holder 200b is also substantially a rectangular box with its bottom side 201b open. Unlike the attachment holder 200a shown in FIG. 4A, a peripheral side 203b of the attachment holder 200b forms an opening, which brings more convenience to the mounting and detachment from the attachment holder 200b of an attachment.

Referring to FIG. 4C, it schematically illustrates an attachment holder 200c according to another embodiment of the present application. Similar to the accessory holder 200a shown in FIG. 4A, the accessory holder 200c is also substantially in a box. The bottom side 201c of the attachment holder 200c is open, and a plurality of protrusions 203c are provided on inner surfaces of the sidewalls. These protrusions 203c abut against an attachment (not shown) to limit the transverse freedoms of the attachment.

Referring to FIG. 4D, it schematically illustrates an attachment holder according to another embodiment of the present application. In the present embodiment, the attachment holder comprises two independent fins 201d and 203d, respectively fixed to the two opposite sidewalls of an attachment 210d. Inspired by the present application, it is understood that the number, position, and shape of independent fins may be determined based on specific circumstances and needs. For example, four fins may be provided and fixed to the four sidewalls of the attachment, respectively.

Referring to FIG. 4E, it schematically illustrates an attachment holder 200e according to a further embodiment of the present application. In the present embodiment, the attachment holder 200e comprises a plurality of fins 201e and a connecting part 203e that connects and fixes these fins. These fins 201e surround and define a middle portion which is to receive and retain an attachment (not shown). In one embodiment, the plurality of fins 201e and the connecting part 203e may be integrally formed.

Referring to FIG. 4F, it schematically illustrates an attachment holder 200f according to a further embodiment of the present application. In the present embodiment, the attachment holder 200f is substantially a box. The bottom side and the top side of the attachment holder 200f are both open, and a plurality of raised structures 201f are formed on outer surfaces of the sidewalls for correctly positioning and retaining the attachment holder 200f in an attachment holder receiving portion of an attachment template. A plurality of fins 203f are formed on inner surfaces of the sidewalls for correctly positioning and retaining an attachment in the attachment holder 200f.

Referring to FIG. 4G, it schematically illustrates an attachment holder 200g according to a further embodiment of the present application. In the present embodiment, the attachment holder 200g is formed with inner and outer layers. The outer layer wall 201g and inner layer wall 203g are both in a shape of box with their bottom sides open. The outer layer wall 201g and the inner layer wall 203g are connected and fixed to each other by a plurality of fins 205g. The outer surface of the outer layer wall 201g is provided with a plurality of raised structures 207g for correctly positioning and retaining the attachment holder 200g in an attachment holder receiving portion of an attachment template. An attachment (not shown) is received and retained in the space surrounded by the inner layer wall 203g.

Referring to FIG. 4H, it schematically illustrates an assembly of an attachment holder 200h and an attachment 210h according to another embodiment of the present application. In the present embodiment, the attachment holder 200h is substantially in the shape of a box. The attachment 210h is fixed in the attachment holder 200h using an adhesive 201h. A bottom surface of the attachment 210h is provided with an adhesion layer 211h, and a bottom side of the attachment holder 200h is provided with an isolation film 203h for isolating the adhesion layer 211h of the attachment 210h. The isolation film 203h is fixed to the bottom side of the attachment holder 200h, for example, fixed onto an edge of the bottom side of the attachment holder 200h by means of adhesive or thermos bonding.

In one embodiment, an attachment and an attachment holder may be made of a same material, such as a polymer material such as wear-resistant resin or plastic etc., or a hard inorganic material such as ceramic and metal etc.

In one embodiment, an attachment and an attachment holder may be fabricated separately and then assembled to obtain an attachment and attachment holder assembly. In one embodiment, the production and assembling of the attachment and the attachment holder may be carried out by an automated apparatus.

In one embodiment, an attachment and an attachment may be integrally formed, for example, may be made by 3D printing or injection molding etc. In one embodiment, the attachment and the attachment holder may be fixed to each other using a weakened part to facilitate detachment after the mounting of the attachment.

In one embodiment, an attachment may be made of a material with a high rigidity, whereas an attachment holder may be made of an elastic material, such as silicone. The attachment holder and the attachment may be assembled by interference fit, and the attachment may be correctly positioned and fixed by squeezing the material of the attachment holder. Likewise, interference fit may also be used for assembling the attachment holder and an attachment holder receiving portion, thereby correctly positioning and fixing the attachment holder by squeezing the material of the attachment holder.

Referring to FIG. 5, it schematically illustrates a portion of an attachment mounting template assembly 400 according to one embodiment of the present application.

The attachment mounting template assembly 400 comprises an attachment mounting template 401, which is similar to the attachment mounting template 101 shown in FIG. 1, which is an one-piece shell that forms a tooth-receiving cavity and an attachment holder receiving portion 403 at a predetermined position. An attachment holder 405 is received and retained in the attachment holder receiving portion 403. In one embodiment, the attachment holder 405 may be fixed in the attachment holder receiving portion 403 using an adhesive 409.

An attachment 411 is fixed in the inner side of attachment holder 405. In one embodiment, the attachment 411 and the attachment holder 405 are integrally formed, and they are fixed to each other by a weakened part 413. After the attachment 411 is adhered onto a tooth, the detachment of the attachment holder 405 from the attachment 411 can be achieved easily.

The bottom surface of the attachment 411 is provided with an adhesion layer 415. In one embodiment, the adhesion layer 415 may comprise a base material and an adhesive, wherein the base material may be a loose or tight frame made of an organic or inorganic fiber, such as a non-woven material, or may also be a textile or woven fabric with micro pores, such as cloth, silk, paper, etc., or may also be a loose material with a porous structure, such as sponge, pumice, foam or, porous gel etc., may also be a material with a frame structure such as a flexible polymer frame, or may also be a particle collection composed of a large number of particles or micro structures, such as micro plastic particles or artificial soil. The micro pores and internal cavities of the base material is permeated with, accommodate, adsorb, mix, polymerize or attract by electrostatic or surface tension the adhesive, so that the base material and the adhesive form an integrated adhesion layer. The adhesion layer has a better ability to maintain its own shape than an adhesive by itself.

An isolation film 417 is provided at the opening of the attachment holder receiving portion 403 on a side adjacent to a tooth, and isolates the attachment and attachment holder assembly in the attachment holder receiving portion 403 to avoid contamination of the adhesion layer 415 by external environment.

When the attachment is mounted, the isolation film 417 is removed first. Then, the attachment mounting template assembly 400 is put on a patient’s teeth, so that the adhesion layer 415 on the bottom surface of the attachment 411 tightly abuts against a tooth’s surface. In one embodiment, the attachment mounting template 401 may be made of a thin and soft film material, and the adhesion layer 415 on the bottom surface of the attachment 411 can be made to tightly abut against the tooth’s surface by pressing the top side (i.e. the side away from the tooth) of the attachment holder receiving portion 403. Then, the adhesive of the adhesion layer 415 is caused to cure, thereby firmly adhering the attachment 411 to the tooth’s surface. In one embodiment, the adhesive of the adhesion layer 415 may be a photocurable adhesive, and is cured by beam of light at a specific wavelength. Next, the attachment mounting template 401 is removed from the patient’s teeth. In one embodiment, after the attachment mounting template 401 is removed, the attachment holder 405 detaches from the attachment mounting template 401 and still remains fixed to the attachment 411. At this time, a tool (such as a pliers) may be used to remove the attachment holder 405 from the attachment 411 which is fixed onto the tooth. In another embodiment, after the attachment mounting template 401 is removed, the attachment holder 405 detaches from the attachment 411 along with the attachment mounting template 401. Inspired by the present application, it is understood that whether the attachment holder 405 detaches from the attachment 411 along with the attachment mounting template 401, or remains fixed to the attachment 411 after the attachment mounting template 401 is removed depends on how firm the attachment holder 405 is retained in the attachment receiving portion 403. If the firmness is greater than the connection firmness between the attachment holder 405 and the attachment, the attachment holder 405 will detach from the attachment 411 along with the attachment mounting template 401. Otherwise, the attachment holder 405 will remain fixed to the attachment 411.

Although in the above embodiments, only one attachment holder receiving portion is provided on an attachment mounting template for illustrative purpose, it is understood that type, number, and orientation of attachment may be determined based on specific needs and situations.

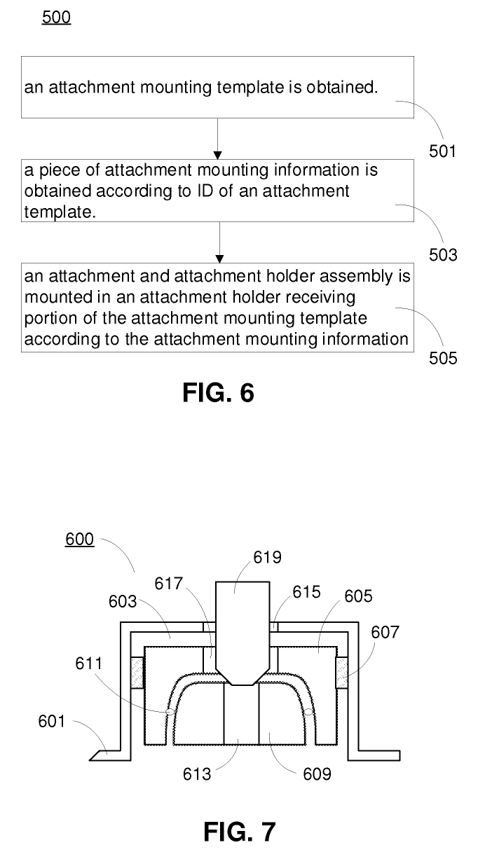

Referring to FIG. 6, it is a schematic flow chart of a method 500 of fabricating an attachment mounting template assembly according to one embodiment of the present application.

In 501, an attachment mounting template is obtained.

As mentioned above, the attachment mounting template may be fabricated by a method such as thermo-forming process or 3D printing, and will not be described in detail here.

In 503, attachment mounting information is obtained based on identity information of the attachment mounting template.

In one embodiment, the identity information of the attachment mounting template may be printed on the attachment mounting template. In another embodiment, the identity information of the attachment mounting template may also be engraved on the attachment mounting template. In another embodiment, the identity information of the attachment mounting template may also be printed on a label stuck to the attachment mounting template or on its packaging bag.

In one embodiment, the identity information of the attachment mounting template may be a combination of digits and/or letters. In another embodiment, the identity information of the attachment mounting template may also be a barcode. In a further embodiment, the identity information of the attachment mounting template may also be a QR code.

In one embodiment, the identity information of the attachment mounting template may be obtained by scanning with a scanning device. In another embodiment, the identity information of the attachment mounting template may also be manually input into a computer by an operator.

In one embodiment, after the identity information of the attachment mounting template is obtained, the computer may obtain the attachment mounting information of the attachment mounting template from a database according to the identity information. In one embodiment, a database that contains mounting information of various attachment mounting templates may be stored in a server connected to the computer or in the computer.

Inspired by the present application, it is understood that an attachment mounting template may be used to mount a plurality of attachments of the same type or different types. In one embodiment, the same type of attachment and attachment holder assembly may be a standard part to facilitate mass production.

In 505, an attachment and attachment holder assembly is mounted in an attachment holder receiving portion of the attachment mounting template according to the attachment mounting information.

In one embodiment, the attachment and attachment holder assembly may be manually mounted in the attachment holder receiving portion of the attachment mounting template. In the present embodiment, after the attachment mounting information is obtained, the computer may graphically present the attachment mounting information on a display to instruct an operator to mount the correct attachment and attachment holder assembly in a correct direction in the correct attachment holder receiving portion. For example, an image of the attachment mounting template may be shown on the display, and the type and the mounting direction of a corresponding attachment and attachment holder assembly may be shown for each attachment holder receiving portion. For example, the types of attachment and attachment holder assemblies may be distinguished using colors. For example, the computer may mark an attachment holder receiving portion on the screen with a specific color according to the attachment mounting information, to indicate the type of the attachment and attachment holder assembly corresponding to the attachment holder receiving portion. The operator may obtain the corresponding type of attachment and attachment holder assembly from a corresponding tray according to the corresponding mark. For another example, the types of attachment and attachment holder assemblies may be distinguished using different graphics. For example, the computer may mark an attachment holder receiving portion with a specific graphic (for example, triangle, square, circle, pentagram, etc.) on the screen according to the attachment mounting information to indicate the type of attachment and attachment holder assembly corresponding to the attachment holder receiving portion. The operator may obtain the corresponding type of attachment and attachment holder assembly from a corresponding tray according to the corresponding graphic mark.

In one embodiment, if the attachment holder and the attachment holder receiving portion are provided with an error-proofing structure, the attachment mounting information may not comprise mounting direction of the attachment and attachment holder assembly.

In another embodiment, a piece of attachment mounting information may be used to control a device to automatically mount the attachment and attachment holder assembly in the attachment holder receiving portion of the attachment mounting template. In the present embodiment, the attachment mounting information may comprise type of attachment and attachment holder assembly, as well as position information of the attachment holder receiving portion. In one embodiment, the device may be a robotic arm.

Another aspect of the present application provides another attachment mounting approach, which utilizes another attachment mounting template assembly to mount an attachment, which attachment mounting template assembly comprises an attachment mounting template, an attachment holder and an attachment. The attachment forms a hollow portion from a top surface to a bottom surface (i.e., a bonding surface) to allow adhesive to be injected from the top surface through the hollow portion to the bottom surface and fill the hollow portion. The adhesive, after curing, forms a part of the attachment, and adheres the attachment to a tooth’ surface.

The attachment mounting template is a one-piece shell, which forms a cavity for receiving teeth and forms an attachment holder receiving portion at a predetermined position. The holder receiving portion receives the attachment holder, and the attachment holder is located between the attachment holder receiving portion and the attachment, and retains and correctly positions the attachment within the attachment holder receiving portion. The attachment holder receiving portion has an opening on a side facing a tooth, which enables the attachment to be adhered onto the tooth’s surface.

On the one hand, since the attachment is preformed, i.e., it is a cured component, the attachment may be made by a conventional injection molding or sintering method with a more economical material, thereby at least partially replacing the more expensive adhesive (such as a photocurable adhesive material), and therefore effectively reducing the cost. On the other hand, the size of the attachment holder is larger than that of the attachment, so that the attachment holder and the attachment can be placed in the correct direction in the attachment holder receiving portion easier manually or automatically.

Referring to FIG. 7, it schematically illustrates a portion of an attachment mounting template assembly 600 according to one embodiment of the present application.

The attachment mounting template assembly 600 comprises an attachment mounting template 601, which is, similar to the attachment mounting template 101 shown in FIG. 1, a one-piece shell forming a tooth-receiving cavity and an attachment holder receiving portion 603 at a predetermined position. An attachment holder 605 is retained in the attachment holder receiving portion 603. In one embodiment, the attachment holder 605 may be fixed in the attachment holder receiving portion 603 using an adhesive 607.

An attachment 609 is retained in the inner side of attachment holder 605. In one embodiment, the attachment 609 and attachment holder 605 may be integrally formed, and they may be fixed to each other through a weakened part 611. After the attachment 609 is adhered onto a tooth, the attachment holder 605 can be detached from the attachment 609 easily.

The attachment 609 forms a hollow portion 613 from a top surface to a bottom surface to allow adhesive to be injected from the top surface through the hollow portion 613 to the bottom surface and be distributed on the bottom surface, thereby adhering the attachment 609 onto the tooth’ surface. Correspondingly, the top of the attachment holder receiving portion 603 (i.e., the side away from the tooth) is provided with an opening 615, and the top of the attachment holder 605 is provided with an opening 617 to allow an adhesive injector 619 to inject the adhesive into the hollow portion 613.

In one embodiment, the adhesive injector 619 may be electronically controlled, and the attachment may be a standard part with a unified shape and size. The injection dose and pressure of the adhesive injector 619 may be pre-set to avoid excessive or insufficient injection.

Inspired by the present application, it is understood that the structure of the attachment holder 605 holding the attachment 609 may employ the structures of the accessory holders in the above embodiments.

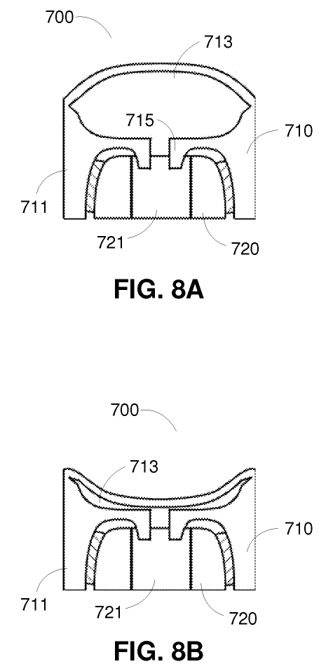

Referring to FIG. 8A, it schematically illustrates the cross-section of an attachment and attachment holder assembly 700 according to another embodiment of the present application.

The attachment and attachment holder assembly 700 comprises an attachment holder 710 and an attachment 720. The attachment 720 forms a hollow portion 721 extending from the top surface to the bottom surface to allow adhesive to be injected from the opening of the top surface to the bottom surface, thereby adhering the attachment 720 to a tooth’s surface.

The attachment holder 710 comprises an attachment retention portion 711 for retaining and positioning the attachment 720 in an attachment holder receiving portion of an attachment mounting template (not shown). The attachment holder 710 further comprises an adhesive storage portion 713 which is located on a side of the attachment retention portion 711 away from the tooth and which is configured to store adhesive. The adhesive storage portion 713 forms an adhesive injection nozzle 715 on a side adjacent to the attachment 720. The adhesive injection nozzle 715 is tightly engaged with the opening on the top surface of the accessory 720, so that the adhesive inside the adhesive storage portion 713 can be injected into the hollow portion 721. In the present embodiment, the adhesive storage portion 713 is a bladder that can be squeezed and integrated with the accessory retention portion 711. After being squeezed, the adhesive in the bladder will be squeezed through the adhesive injection nozzle 715 into the hollow portion 721.

Referring to FIG. 8B, it schematically illustrates a state of the adhesive storage portion 713 shown in FIG. 8A after being squeezed.

In one embodiment, a photocurable adhesive may be employed, and the adhesive storage portion 713 may be made of an opaque material to prevent the adhesive in the adhesive storage portion 713 from curing before injected into the hollow portion 721.

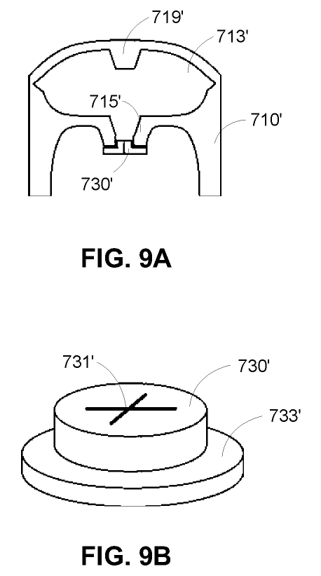

Referring to FIG. 9A, it schematically illustrates an attachment holder 710’ according to another embodiment of the present application.

The attachment holder 710’ is similar to the attachment holder 710 shown in FIG. 8A and FIG. 8B, except that: (1) a protruding plug 719’ is provided at the top of the adhesive storage portion 713’, and after the adhesive storage portion 713’ is fully squeezed, the plug 719’ will be inserted into an injection nozzle 715’ to squeeze the remaining adhesive in the adhesive storage portion 713’ out; (2) a seal 730’ is provided at an end of the injection nozzle 715’, to prevent the adhesive from leaking out before the adhesive storage portion 713’ is squeezed, wherein the seal 730’ may be made of an elastic soft material (such as silicone or rubber), and may be provided with a narrow opening 731’ (as shown in a cross opening in FIG. 9B) that runs through its top and bottom surfaces, so that only after the adhesive storage portion 713’ is squeezed, the adhesive therein can be squeezed out through the opening 731’. The seal 730’ can also form a flange 733’ with a size larger than the injection nozzle 713’, a top surface of the flange 733’ abuts against the injection nozzle 713’, and a bottom surface of the flange 733’ abuts against the accessory (not shown), thereby playing a role of retaining and positioning the seal 730’.

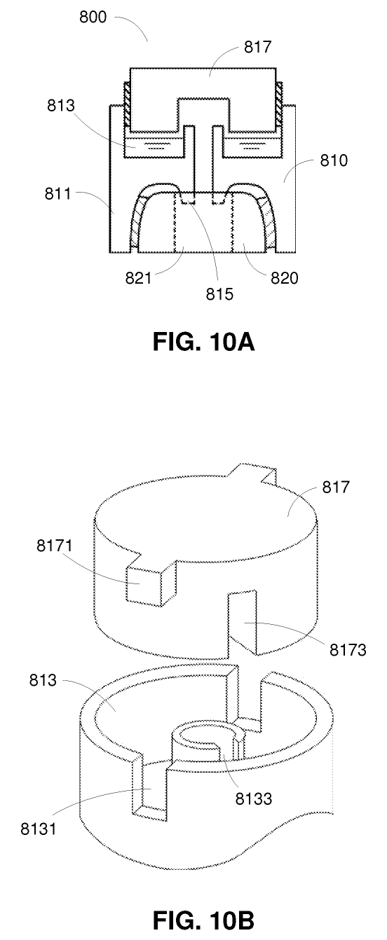

Referring to FIG. 10A, it schematically illustrates a cross section of an attachment and attachment holder assembly 800 according to another embodiment of the present application.

The attachment and attachment holder assembly 800 comprises an attachment holder 810 and an attachment 820. The attachment 820 forms a hollow portion 821 that extends from a top surface to a bottom surface to allow adhesive to be injected from an opening of the top surface to the bottom surface, thereby adhering the attachment 820 to a tooth’s surface.

The attachment holder 810 comprises an attachment retention portion 811 for retaining and positioning the attachment 820 within the attachment holder receiving portion (not shown in the figure) of the attachment mounting template. The attachment holder 810 further comprises an annular adhesive storing reservoir 813 which is located on a side of the attachment retention portion 811 away from the tooth and configured to store an adhesive. The middle of the annular adhesive storing reservoir 813 extends towards the attachment 820 and forms an adhesive injection pipe 815, which is tightly engaged with the opening on the top surface of the attachment 820, so that the adhesive in the annular adhesive storing reservoir 813 can be injected into the hollow portion 821. In the present embodiment, the attachment holder 810 further comprises a piston 817 with a U-shaped cross-section which piston 817 matches with the annular adhesive storing reservoir 813. By pushing the piston 817, the adhesive in the annular adhesive storing pool 813 will be injected through the adhesive injection pipe 815 into the hollow portion 821 of the attachment 820. The adhesive injection pipe 815 extends into the annular adhesive storing reservoir 813, and an inner wall of the annular adhesive storing reservoir 813 forms the wall of this section of the adhesive injection pipe 815 to prevent leakage of the adhesive.

Referring to FIG. 10B, it illustrates the annular adhesive storing reservoir 813 and piston 817 shown in FIG. 10A.

Two positioning blocks 8171 are formed on an outer side surface of the piston 817, and correspondingly, two positioning slots 8131 are formed on an outer sidewall of the annular adhesive storing reservoir 813. The positioning blocks 8171 mate with the positioning slots 8131 to prevent relative rotation between the piston 817 and the annular adhesive storage pool 813. In addition, before the positioning blocks 8171 are aligned with the positioning slots 8131, the piston 817 cannot be pushed, thereby preventing mis-operation.

An opening 8173 is formed on the sidewall of the piston, and correspondingly an opening 8133 is also formed on an inner wall of the annular adhesive storing reservoir 813. The opening 8173 and the opening 8133 are aligned with each other. When the piston 817 is pushed down, the adhesive in the annular adhesive storing reservoir 813 will enter the injection pipe 815 through the openings 8173 and 8133.

Inspired by the present application, it is understood that the shape of the hollow portion of the attachment is not limited to the above embodiments, and may be any suitable shape.

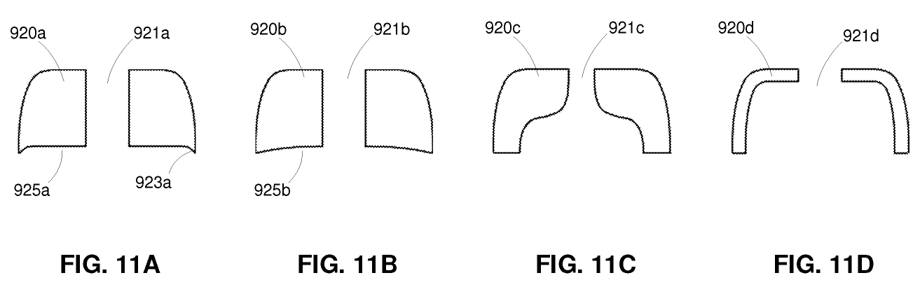

Referring to FIG. 11A, it schematically illustrates a cross-section of an attachment 920a according to another embodiment of the present application. A hollow portion 921a of the attachment 920a comprises a channel extending from a top surface to a bottom surface, and the edge of the bottom surface of the attachment protrudes downwards to form a sharp wall 923a, to keep the adhesive in within the attachment and prevent leakage of the adhesive. The bottom surface of the attachment 920a is slightly inwardly-concave to form an adhesive storage cavity 925a, to ensure that the adhesive can substantially cover the bottom surface of the attachment 920a, thereby ensuring the firm adhesion of the attachment 920a. In one embodiment, substantially the entire bottom surface of the accessory is inwardly-concave to ensure that the adhesive can substantially cover its entire bottom surface. For example, the inwardly-concave portion may account for more than 70%, even more than 80%, or even more than 90% of the area of the bottom surface. In one embodiment, uneven structures may be formed on the surface of the inwardly-concave portion of the bottom surface of the attachment to increase contact area with the adhesive and further enhance the firmness of the adhesion.

Referring to FIG. 11B, it schematically illustrates a cross-section of an attachment 920b according to another embodiment of the present application. The hollow portion 921b of the attachment 920b comprises a channel extending from a to surface to a bottom surface, the bottom surface of the attachment 920b forms a slightly inwardly-concave arcuate surface and forms an adhesive storing cavity 925b to ensure the firm adhesion of the attachment 920b.

Referring to FIG. 11C, it schematically illustrates a cross-section of an attachment 920c according to another embodiment of the present application. The hollow portion 921c of the attachment 920c is substantially funnel-shaped.

Referring to FIG. 11D, it schematically illustrates a cross-section of an attachment 920d according to another embodiment of the present application. The attachment 920d is substantially in a shape of a hollow shell with a large hollow portion 921d.

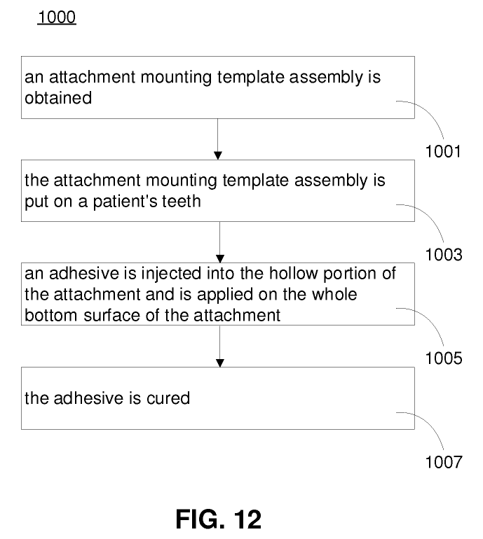

Referring to FIG. 12, it schematically illustrates a flow chart of a method 1000 of adhering an attachment onto a tooth according to a further embodiment of the present application.

In 1001, an attachment mounting template assembly is obtained.

In one embodiment, the attachment mounting template assembly comprises an attachment mounting template, which is a one-piece shell that forms a tooth receiving cavity and an attachment holder receiving portion for receiving an attachment at a selected position; an attachment holder received in the attachment holder receiving portion for retaining and fixing an attachment within the attachment holder receiving portion; and an attachment which forms a hollow portion extending from a top surface to a bottom surface, and is retained and fixed by the attachment holder in the attachment holder receiving portion, wherein the attachment holder is located between the attachment holder receiving portion and the attachment.

In 1003, the attachment mounting template assembly is put on a patient’s dentition.

In 1005, an adhesive is injected into the hollow portion of the attachment and is applied on the whole bottom surface of the attachment.

For the attachment mounting template assembly 600 shown in FIG. 7, the adhesive injector 619 may be operated to pass through the attachment mounting template 601 and the attachment holder 605, to engage with the opening of the hollow portion 613 on the top surface of the attachment 609, and then a certain amount of adhesive is injected into the hollow portion 613. Ideally, the adhesive fills the whole hollow portion 613 and is applied on the entire bottom surface of the accessory 609.

For the embodiments shown in FIGS. 8A-10B, the adhesive may be squeezed into the hollow portion and bottom surface of the attachment by simply pressing the adhesive storing portion.

In 1007, the adhesive is cured.

In one embodiment, a photocurable adhesive may be used, and cured by irradiating the adhesive with a beam of light of a specific wavelength, so that the adhesive in the hollow portion is cured to form a part of the attachment, and the adhesive on the bottom surface of the attachment is cured to adhere the attachment onto a tooth’s surface.

While various aspects and embodiments have been disclosed herein, other aspects and embodiments will be apparent to those skilled in the art, inspired by the present application. The various aspects and embodiments disclosed herein are for illustration only and are not intended to be limiting, and the scope and spirit of the present application shall be defined by the following claims.

Likewise, the various diagrams may depict exemplary architectures or other configurations of the disclosed methods and systems, which are helpful for understanding the features and functions that can be included in the disclosed methods and systems. The claimed invention is not restricted to the illustrated exemplary architectures or configurations, and desired features can be achieved using a variety of alternative architectures and configurations. Additionally, with regard to flow diagrams, functional descriptions and method claims, the order in which the blocks are presented herein shall not mandate that various embodiments of the functions shall be implemented in the same order unless otherwise the context specifies.

Unless otherwise specifically specified, terms and phrases used herein are generally intended as “open” terms instead of limiting. In some embodiments, use of phrases such as “one or more”, “at least” and “but not limited to” should not be construed to imply that the parts of the present application that do not use similar phrases intend to be limiting.

We claim:

1. An attachment and attachment holder assembly, comprising:
an attachment which is to be adhered onto a tooth’s surface to form a protrusion and to interact with a shell-shaped tooth repositioner to provide an auxiliary force system for an orthodontic treatment, where the attachment forms a bottom surface, the attachment is to be adhered onto the tooth’s surface by bonding the bottom surface and the tooth’s surface; and
an attachment holder configured to retain and correctly position the attachment in an attachment holder receiving portion of an attachment mounting template to mount the attachment,
where the attachment mounting template is a one-piece shell, and forms a tooth-receiving cavity and the attachment holder receiving portion at a predetermined position, when the attachment and attachment holder assembly is received in the attachment holder receiving portion, the attachment holder is located between the attachment mounting template and the attachment,
where the attachment and the attachment holder are fabricated separately, and the attachment and attachment holder assembly is obtained by assembling the attachment and the attachment holder before the attachment and attachment holder assembly is mounted in the attachment holder receiving portion,
where the structure of the attachment holder is such that it can only be removed from the attachment along a direction which is opposite to the direction that the bottom surface faces.

2. The attachment and attachment holder assembly of claim 1, wherein the attachment is defined by the bottom surface, a side surface and a top surface, the attachment holder engages with the side surface and the top surface with the bottom surface exposed.

3. The attachment and attachment holder assembly of claim 1, wherein the attachment and the attachment holder are fixed to each other by an adhesive or a retaining structure.

4. The attachment and attachment holder assembly of claim 1, wherein the attachment holder comprises a plurality of fins distributed around the attachment, to correctly position the attachment in the attachment holder receiving portion.

5. The attachment and attachment holder assembly of claim 1, wherein the attachment holder comprises a closed sidewall that surrounds the attachment.

6. The attachment and attachment holder assembly of claim 1, wherein the attachment holder forms an error-proofing structure capable of preventing the attachment holder from being mounted in the holder receiving portion in a wrong direction.

7. The attachment and attachment holder assembly of claim 1, wherein an adhesion layer is provided on the bottom surface of the attachment, to adhere the attachment onto the tooth’s surface.

8. The attachment and attachment holder assembly of claim 7, wherein the attachment and attachment holder assembly further comprises an isolation film fixed at the edge of a bottom side of the attachment holder, to isolate the adhesion layer.

9. An attachment mounting template assembly for adhering an attachment at a selected position on a surface of a selected tooth, comprising:
an attachment, an attachment mounting template and an attachment holder,
where the attachment is to be adhered onto a tooth’s surface, to form a protrusion and to interact with a shell-shaped tooth repositioner to provide an auxiliary force system for an orthodontic treatment, the attachment forms a bottom surface, the attachment is to be adhered onto the tooth’s surface by bonding the bottom surface and the tooth’s surface,
the attachment mounting template is a one-piece shell, and forms a tooth-receiving cavity and an attachment holder receiving portion at a selected position,
the attachment holder is received in the attachment holder receiving portion, and retains and correctly positions the attachment within the attachment holder receiving portion,
the attachment holder is located between the attachment holder receiving portion and the attachment,
when the attachment mounting template assembly is put on a patient’s teeth, the attachment is located at a selected position on a surface of a selected tooth,
the attachment and attachment holder assembly is obtained by assembling the attachment and the attachment holder before the attachment and attachment holder assembly is mounted in the attachment holder receiving portion,
the structure of the attachment holder is such that it can only be removed from the attachment along a direction which is opposite to the direction that the bottom surface of the attachment faces.

10. The attachment mounting template assembly of claim 9, wherein the attachment is defined by the bottom surface, a side surface and a top surface, the attachment holder engages with the side surface and the top surface of the attachment with the bottom surface of the attachment exposed.

11. The attachment mounting template assembly of claim 9, wherein the attachment holder is fixed in the attachment holder receiving portion by an adhesive or a retaining structure.

12. The attachment mounting template assembly of claim 9, wherein the attachment and the attachment holder are fixed to each other by an adhesive or a retaining structure.

13. The attachment mounting template assembly of claim 9, wherein the attachment holder and the attachment holder receiving portion form an error-proofing structure capable of preventing the attachment holder from being mounted in the holder receiving portion in a wrong direction.

14. The attachment mounting template assembly of claim 9, wherein the attachment holder comprises a plurality of fins distributed around the attachment, to correctly position the attachment in the attachment holder receiving portion.

15. The attachment mounting template assembly of claim 9, wherein an adhesion layer is provided on the bottom surface of the attachment to adhere the attachment onto the tooth’s surface.

16. The attachment mounting template assembly of claim 15, wherein the assembly further comprises an isolation film fixed at the edge of a bottom side of the attachment holder to isolate the adhesion layer.

17. The attachment mounting template assembly of claim 9, wherein the attachment template forms a plurality of same attachment holder receiving portions, and the attachment mounting template assembly comprises a plurality of same attachment and attachment holder assemblies which are received in the plurality of attachment holder receiving portions respectively.

18. A method for fabricating an attachment mounting template assembly, comprising:
assembling an attachment and an attachment holder to obtain an attachment and attachment holder assembly; and
mounting the attachment and attachment holder assembly in an attachment holder receiving portion of an attachment mounting template to obtain an attachment mounting template assembly,
where the attachment is to be adhered onto a tooth’s surface, to form a protrusion and to interact with a shell-shaped tooth repositioner to provide an auxiliary force system for an orthodontic treatment,
the attachment forms a bottom surface, the attachment is to be adhered onto the tooth’s surface by bonding the bottom surface and the tooth’s surface,
the attachment holder retains and correctly positions the attachment within the attachment holder receiving portion,
the attachment mounting template is a one-piece shell, and forms a tooth-receiving cavity and the attachment holder receiving portion at a selected position,
the structure of the attachment holder is such that it can only be removed from the attachment along a direction which is opposite to the direction that the bottom surface of the attachment faces.
